(19) United States
(12) Patent Application Publication
(10) Pub. No.: US 2010/0039254 A1
(43) Pub. Date: Feb. 18, 2010

(54) TRANSPORTATION ACTIVITY INFORMATION TOOLS AND TECHNIQUES FOR MOBILE DEVICES

(75) Inventors: Marcus Donald Cooper, Longview, WA (US); Kevin Taylor Bradley, Washougal, WA (US); Terrence Gene Taylor, Camas, WA (US)

Correspondence Address: MARGER JOHNSON & MCCOLLOM, P.C., 210 SW MORRISON STREET, SUITE 400, PORTLAND, OR, 97204, US

(73) Assignee: iCooper, Inc., Washougal, WA (US)

(21) Appl. No.: 12/537,229

(22) Filed: Aug. 6, 2009

Related U.S. Application Data
(60) Provisional application No. 61/087,072, filed on Aug. 7, 2008.

(51) Int. Cl. G08B 1/08

(52) U.S. Cl. 340/539.11

(57) ABSTRACT

A machine-controlled method can include a mobile electronic device capturing transportation activity information corresponding to a particular transportation activity for a user, evaluating the transportation activity information based on a set of compliance rules, and issuing an alert to the user in response to determining that the transportation activity information is not in conformance with the set of compliance rules.

### CROSS-REFERENCE TO RELATED APPLICATIONS

This application claims the benefit of U.S. Provisional Patent Application Ser. No. 61/087,072, titled “METHOD AND APPARATUS FOR GENERATING A DRIVER LOG,” filed on Aug. 7, 2008, which is hereby incorporated by reference in its entirety herein.

### TECHNICAL FIELD

The disclosed technology pertains to mobile devices, and more particularly to vehicle activity information tools and techniques implemented in connection with mobile devices.

### BACKGROUND

Mobile devices such as cellular/wireless telephones, which are generally referred to as mobile phones, and handheld computing devices such as personal digital assistants (PDAs) have become increasingly popular over the past decade. Many of today's mobile devices have a built-in wireless capability to connect to the Internet and personal or work-related computer systems. Among the wide variety of other features that are generally available with modern mobile devices are the ability to watch streaming video (or download and store videos for later viewing), built-in cameras and/or video recorders, a memory card reader, an interface port such as a USB port, infrared and/or Bluetooth capabilities, WiFi connectivity, and instant messaging.

The continued advances in the technical capabilities of today's mobile devices fuels an ever-growing number of software applications that are specifically geared toward mobile device users. Such consumer applications can include virtually everything from mobile news services to personal organizers to mobile coupons and discount offers to informational guides on local activities and events to tools for creating and managing mobile device-specific websites. Despite the number of mobile device applications that have been developed over the years, there remains a need for effective information management systems directed toward transportation activities.

### SUMMARY

Embodiments of the disclosed technology can include a transportation activity information management system composed of a mobile device application component and a remote data management system that will be referred to herein as a database-in-the-sky (DBITS). Using the mobile device application component, a mobile user can create or update an account with the system. Once the mobile user has an active account with the system, the mobile user can create, edit, and/or delete transportation activities that pertain to the mobile user.

The system can provide the mobile user with a number of transportation activity-specific features. For example, the system can enable the mobile user to add an attachment to virtually any given transportation activity. The system can also enable the mobile user to add a point of interest such as a geographic location that has a connection to the transportation activity. For example, the mobile user can add a starting point or a final destination for the transportation activity.

Certain implementations of the disclosed technology can advantageously provide an electronic display of precise changes in a truck driver's duty status in sequence. In addition, an electronic display of the driver's hours of service can be produced on demand. Such implementations can easily integrate with transportation industry databases and thus qualify as an event on-board recorder (EOBR) system.

In certain embodiments, the system can perform synchronization functions to ensure that the mobile user's activity-specific information stored on his or her mobile device is consistent with the corresponding data that is stored by the DBITS. Should the system encounter any inconsistencies in the data, the system can alert the mobile user to such inconsistencies and provide the mobile user with a mechanism for resolving such data conflicts.

### BRIEF DESCRIPTION OF THE DRAWINGS

FIG. 1 is a block diagram illustrating an example of a transportation activity information management system for mobile devices in accordance with certain implementations of the disclosed technology.

FIG. 2 is a block diagram illustrating an example of a mobile device that can be used in connection with certain implementations of the disclosed technology.

FIG. 3 is a flowchart illustrating an example of a machine-controlled method of setting up the mobile device application component of a transportation activity information management system.

FIG. 4 illustrates an example of a terms and conditions screen in accordance with certain implementations of the disclosed technology.

FIG. 5 illustrates an example of a User Information screen in accordance with certain implementations of the disclosed technology.

FIG. 6 illustrates an example of an Employer Information screen in accordance with certain implementations of the disclosed technology.

FIG. 7 illustrates an example of an Hour Rule screen in accordance with certain implementations of the disclosed technology.

FIG. 8 is a flowchart illustrating an example of a machine-controlled method of entering transportation activity information using a mobile device in accordance with certain implementations of the disclosed technology.

FIG. 9 illustrates an example of a Driver's Daily Log (DDL) screen in accordance with certain implementations of the disclosed technology.

FIG. 10 illustrates an example of a More Information screen in accordance with certain implementations of the disclosed technology.

FIG. 11 illustrates an example of a Vehicle Inspection screen in accordance with certain implementations of the disclosed technology.

FIG. 12 illustrates an example of a Tractor Inspection screen in accordance with certain implementations of the disclosed technology.

FIG. 13 illustrates an example of a Problems Report screen in accordance with certain implementations of the disclosed technology.

FIG. 14 illustrates an example of a Brakes screen in accordance with certain implementations of the disclosed technology.

FIG. 15 illustrates an example of a Pre-Trip Inspection screen in accordance with certain implementations of the disclosed technology.

FIG. 16 is a first example of a Monthly Summary screen in accordance with certain implementations of the disclosed technology.

FIG. 17 is a second example of a Monthly Summary screen in accordance with certain implementations of the disclosed technology.

FIG. 18 illustrates an example of a report in accordance with certain implementations of the disclosed technology.

### DETAILED DESCRIPTION

Embodiments of the disclosed technology pertain to various transportation activity information tools and techniques implemented in connection with mobile devices. As used herein, transportation activity information refers to information pertaining to one or more transportation activities, where a transportation activity refers to an event or item in connection with a trip or the trip itself. As used herein, a mobile user refers to a user, e.g., a truck driver, that uses one or more mobile devices to capture the transportation activity information. Thus, as used herein, transportation activity information can include information that the mobile user desires to or is required to have captured, stored, and/or tracked.

Certain embodiments can include a combination of a data management service and a mobile application intended for use on handheld computing devices such as mobile phones. The mobile application can proactively capture and/or receive, e.g., from a user via a graphical user interface (GUI), transportation activity information. The transportation activity information can be stored remotely in a web-accessible database system that can be monitored, accessed, and/or manipulated via the mobile application or via a web portal. As used herein, the remote database system will be referred to as a database-in-the-sky (DBITS).

Mobile users can enter transportation activity information as free form data that the mobile application can transmit to the DBITS. The system is capable of handling many different types of field data. In certain embodiments, the system can capture field data and associate it with a particular transportation activity before transmitting the data to the DBITS. The mobile user can track the progress of his or her transportation activities via the mobile application. The system can capture any changes the mobile user may make to existing transportation activities and synchronize the mobile device with the DBITS such that corresponding transportation activity records are consistent with each other.

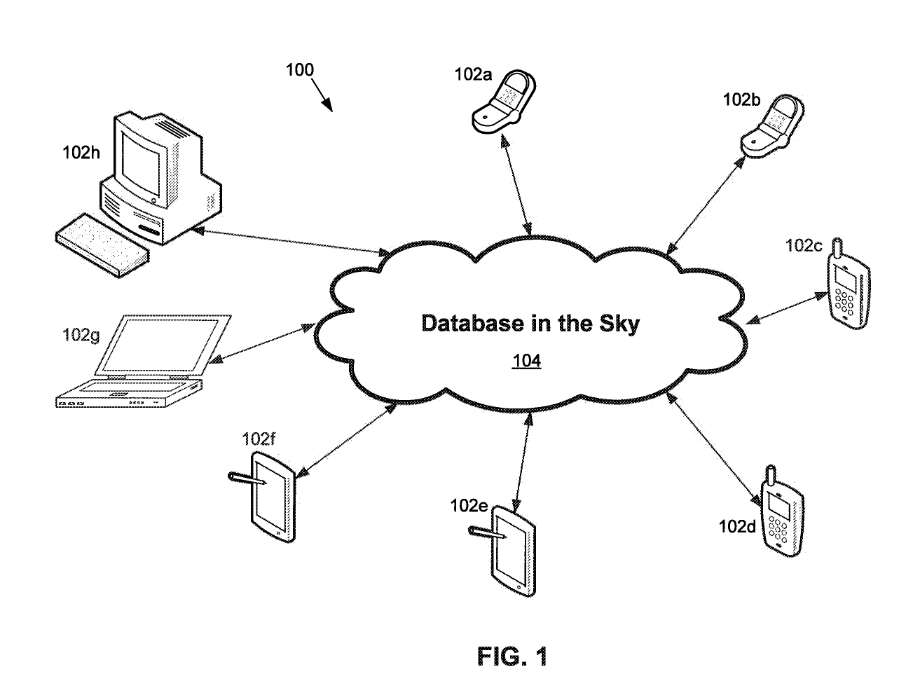

FIG. 1 is a block diagram illustrating an example of a transportation activity information management system 100 for mobile devices such as mobile phones. In the example, a number of mobile devices 102a-102g are each in communication with a remote database system referred to herein as a database-in-the-sky (DBITS) 104. Each of the mobile devices 102a-102g can be used by a corresponding mobile user, such as a truck driver, to add, edit, and/or delete transportation activity information, which can be stored by the DBITS 104.

In certain embodiments, synchronization operations can ensure that the transportation activity information stored by any of the mobile devices 102a-102g is consistent with corresponding transportation activity information stored by the DBITS 104. For example, any of the mobile devices 102a-102g can update a group record or individual records that share transportation activity information. In the example, a backend system 102h is also in communication with the DBITS 104. The backend system 102h can be used for input and reporting purposes in connection with the transportation activity information. For example, a trucking company can use the backend system 102h to run reports for a particular driver or drivers.

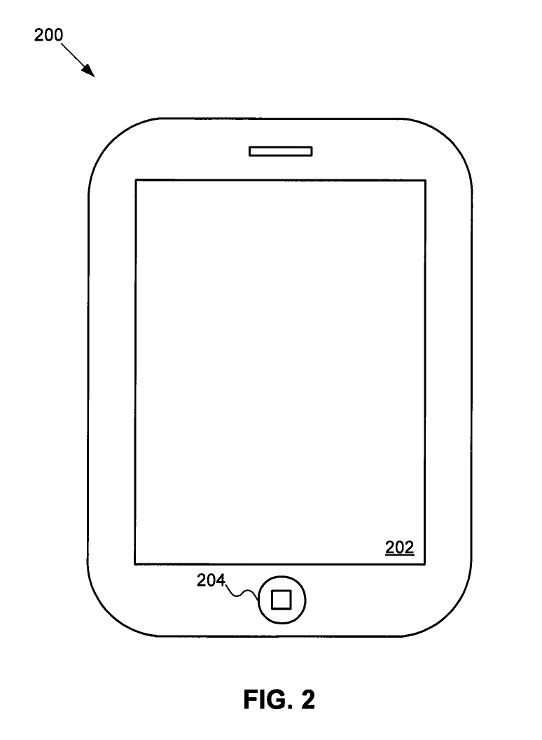

FIG. 2 is a block diagram illustrating an example of a mobile device 200 that can be used in connection with implementations of the disclosed technology. In the example, the mobile device 200 includes a display screen 202 and a button 204. As used herein the display screen 202 can include a traditional screen, a touch screen, or some other type of screen, and can be used to facilitate a graphical user interface (GUI). The mobile device 200 can also include a physical interface (not shown), such as a USB port, that can be used to enable hard-wired communications between the mobile device 200 and a computing device (not shown) such as a personal computer. In certain embodiments, the mobile device 200 can be a mobile phone such as an Apple iPhone. iPhone™ is a trademark of Apple, Inc.

### Mobile Device Application Setup

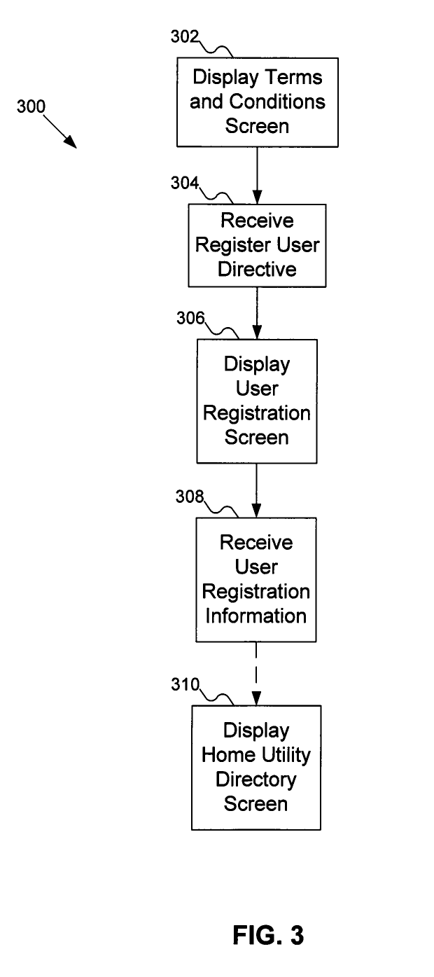

FIG. 3 is a flowchart illustrating an example of a machine-controlled method 300 of setting up the mobile device application component of a transportation activity information management system. At block 302, the mobile user's mobile device displays a terms and conditions screen that provides the terms and conditions for review by the user. Once the user indicates that he or she has accepted the terms and conditions, the method can proceed to block 304. For example, the user can press an “Accept” button to indicate such acceptance. The mobile device will generally prevent the mobile user from advancing to the next screen until the mobile user has indicated acceptance of the listed terms and conditions.

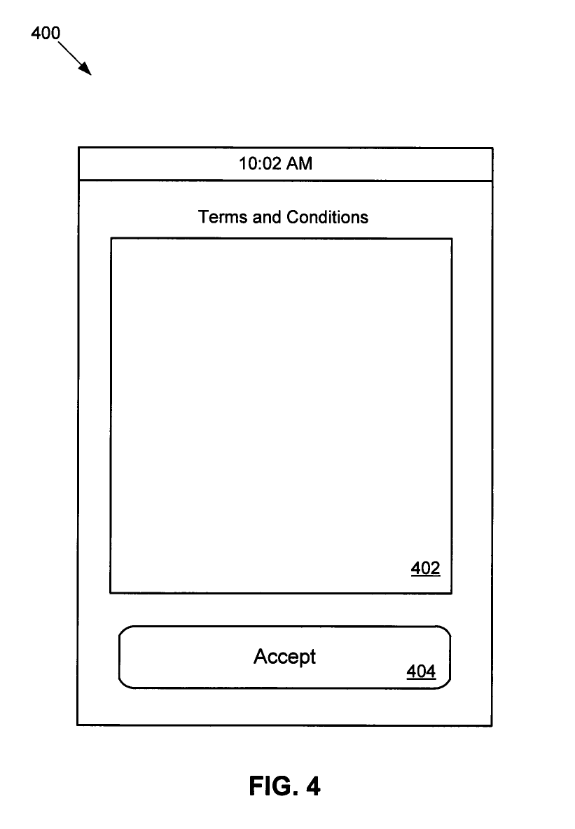

FIG. 4 illustrates an example of a terms and conditions screen 400 in accordance with implementations of the disclosed technology. The terms and conditions screen 400 includes a terms and conditions area 402 that displays the terms and conditions that must be accepted by the mobile user. In certain embodiments, the terms and conditions area 402 is a scrollable text box. Once the mobile user has read the terms and conditions, he or she may indicate acceptance thereof by pressing an “Accept” button 404.

At block 304 of FIG. 3, the mobile user's mobile device displays a user information screen having a number of fields pertaining to various types of user information corresponding to the mobile user. The fields can include, but are not limited to, name, address, phone number, fax number, email address, job title, date of birth, license number, class, license expiration date, medication certification date, and medical certification expiration date. In certain embodiments, the mobile device application can auto-adjust the medical certification expiration date if the medical certification date is modified.

The fields can be any combination of text boxes, dropdown boxes, and the like. In certain embodiments, the mobile device can also request a username and password so that the user need only enter the username and password for subsequent sessions, for example. The mobile device can also provide the mobile user with an option to attach a photograph of himself or herself.

Some or all of the user information can be collected by the application itself. For example, the mobile device can automatically populate the corresponding fields by pulling the mobile user's name, address, phone number, fax number, and/or email address from user settings stored within the mobile device. Alternatively or in addition thereto, some or all of the user information can be entered or edited by the user via a GUI such as a touchscreen on the mobile device, for example. Once the information has been collected, the method can proceed to 306. For example, the user can press a “Save” or “Continue” button to indicate that he or she is ready to proceed to the next screen. In certain embodiments, some or all of the fields must be populated before the mobile device enables such a “Save” or “Continue” button.

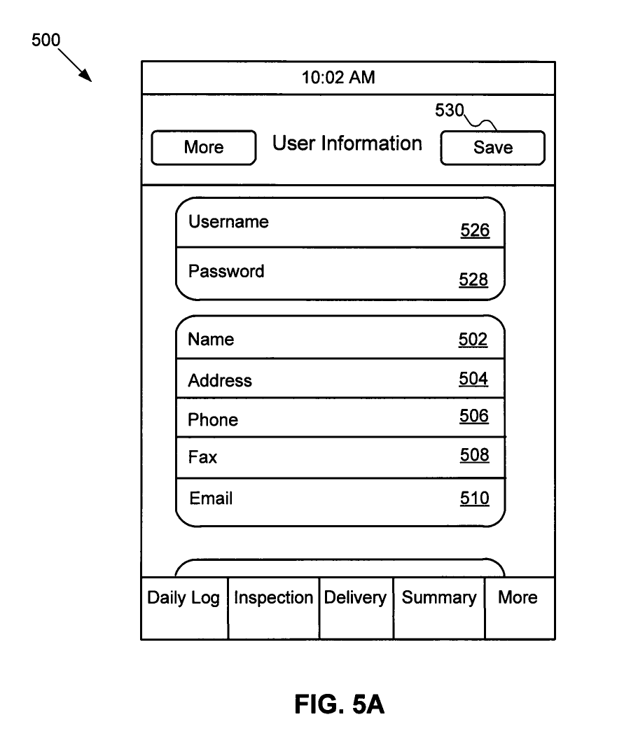

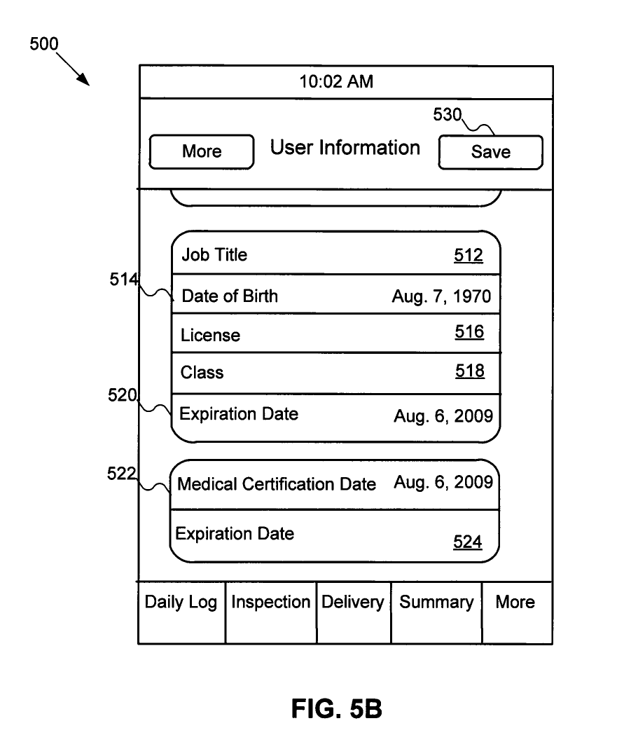

FIG. 5 illustrates an example of a User Information screen 500 in accordance with implementations of the disclosed technology. In the example, the User Information screen 500 includes a name field 502, an address field 504, a phone number field 506, a fax number field 508, an email address field 510, a job title field 512, a date of birth field 514, a license number field 516, a class field 518, a class expiration date field 520, a medical certification date field 522, and a medical certification expiration date field 524.

In the example, the User Information screen 500 also has a username field 526 and a password field 528. In certain embodiments where the user provides a username and password, the mobile device can enable the mobile user to sign on to the application using only the username and password. For example, during subsequent sessions, the mobile device can either disable the other fields or automatically populate the fields with the corresponding stored values from the previous session.

Once the user has completed reviewing, entering, and/or editing the applicable user information, the user can press a “Save” button 530 displayed on the User Information screen 500 in order to prompt the mobile device to proceed to the next screen.

At block 306 of FIG. 3, the mobile user's mobile device displays an employer information screen having a number of fields pertaining to various types of employer information corresponding to the mobile user's employer. The fields can include, but are not limited to, company name, phone number, email address, website, address, time zone, dispatch, service, and roadside assistance. The fields can be any combination of text boxes, dropdown boxes, and the like. In certain embodiments, the mobile device can accept a photograph or image, e.g., a company logo, in addition to or in place of the company name. For example, the mobile device can automatically retrieve a stored image, e.g., from a remote database system, based on the company name.

Some or all of the employer information can be collected by the application itself. For example, the mobile device can automatically populate the corresponding fields by pulling the employer's phone number and/or email address from settings stored within the mobile device. Alternatively or in addition thereto, some or all of the user information can be entered or edited by the user via a GUI such as a touchscreen on the mobile device, for example. Once the information has been collected, the method can proceed to 308 or 310, depending on whether the dispatch type is “long haul.” For example, the user can press a “Save” or “Continue” button to indicate that he or she is ready to proceed to the next screen. In certain embodiments, some or all of the fields must be populated before the mobile device enables such a “Save” or “Continue” button.

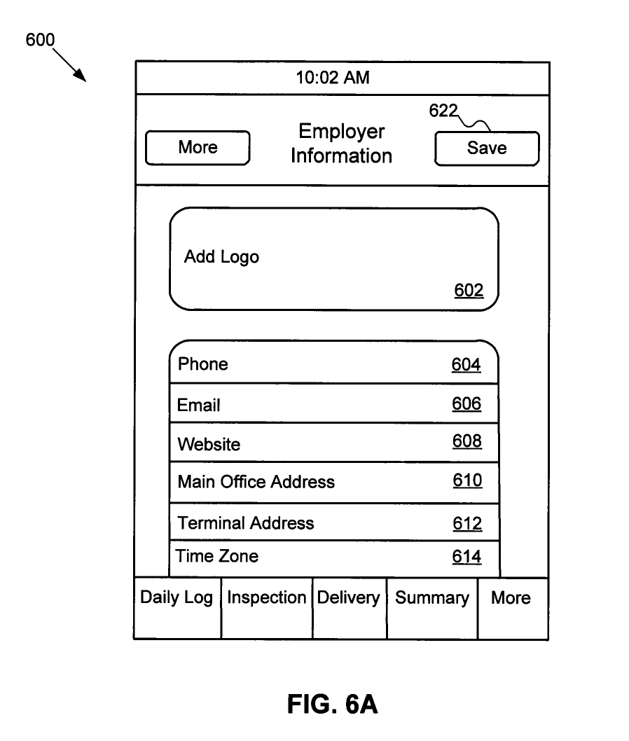

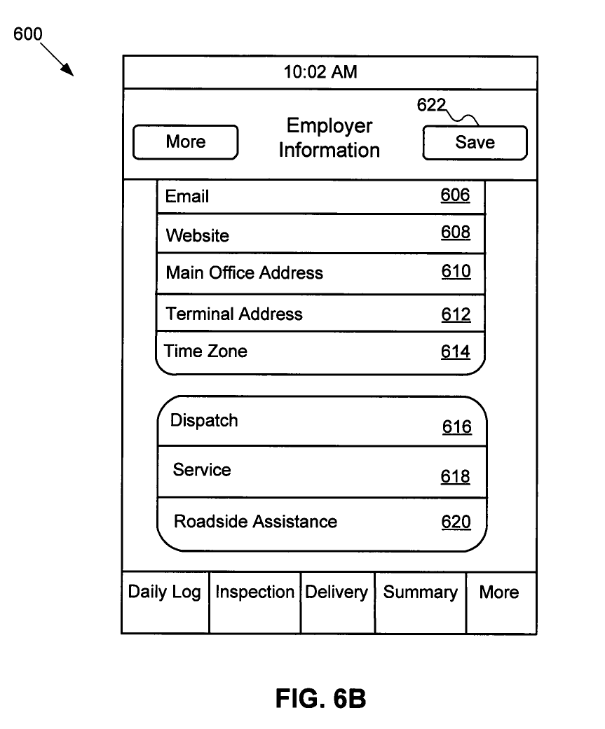

FIG. 6 illustrates an example of an Employer Information screen 600 in accordance with implementations of the disclosed technology. In the example, the Employer Information screen 600 includes an employer name/logo field 602, a phone number field 604, an email address field 606, a website field 608, a main office address field 610, a terminal address field 612, a time zone field 614, a dispatch field 616, a service field 618, and a roadside assistance field 620. Once the user has completed reviewing, entering, and/or editing the applicable employer information, the user can press a “Save” button 622 displayed on the Employer Information screen 600 in order to prompt the mobile device to proceed to the next screen.

In certain situations where a mobile user may have multiple employers, the system can create a separate employer record for any number of the mobile user's employers. For example, the Employer Information screen 600 can display an “Add Employer” button (not shown) that, responsive to being selected by the user, can store the currently displayed employer information in connection with the corresponding employer record, e.g., at a remote datastore, and re-display the Employer Information screen 600 but with blank and/or re-populated fields.

If the dispatch type is “long haul,” the method 300 of FIG. 3 proceeds to 308, where the mobile user's mobile device displays an hour rule screen. The user must choose between a 70/8 rule and a 60/7 rule, for example. Once the user has selected one of the hour rules, the user can press a “Save” or “Continue” button to indicate that he or she is ready to proceed to the next screen. In alternative embodiments, the mobile device can automatically proceed to the next screen responsive to the mobile user selecting, e.g., clicking on, one of the displayed hour rule options.

In the trucking industry, truck drivers need to comply with various regulations concerning the amount of time that they are behind the wheel. For example, a truck driver is not allowed to drive more than 11 consecutive hours after 10 consecutive hours off duty or in sleeper berth. That is, if a truck driver drives for 5 hours, takes a one hour break, and then drives for another 6 hours, he or she cannot drive again until he or she has taken 10 consecutive hours off duty or in sleeper berth.

Another regulation provides that a truck driver may not drive after the 14th hour of active duty following 10 consecutive hours off. That is, if the driver is on duty for two hours, then drives for eight hours, and is then on duty [but not driving] for four hours, he or she is not allowed to drive again until he or she has taken 10 consecutive hours off duty or in sleeper berth.

The 60/7 rule provides that a truck driver may not drive more than 60 hours within a seven day period and the 70/8 rule provides that a truck driver may not drive more than 70 hours in 8 days. It should be noted, however, that the clock resets after 34 consecutive hours off duty.

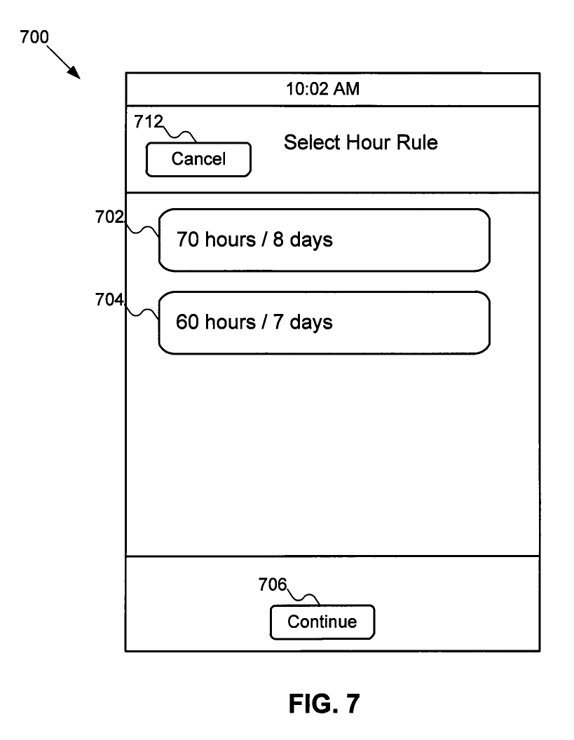

FIG. 7 illustrates an example of an Hour Rule screen 700 in accordance with implementations of the disclosed technology. In the example, the mobile device displays two hour rule options: a 70/8 rule option 702 and a 60/7 rule option 704. Once the mobile user has selected one of the options 702 and 704, the mobile user can press a “Continue” button 706 to prompt the mobile device to proceed to the next screen. Alternatively, the mobile device can automatically proceed to the next screen once the user selects one of the hour rule options 702 and 704.

If the dispatch type is other than “long haul,” the method 300 of FIG. 3 bypasses block 308 and proceeds directly to block 310, where the mobile device displays a Driver's Daily Log (DDL) screen.

In certain embodiments, the mobile device application component can begin by displaying the DDL screen and thus bypass the other setup screens if the mobile user has already completed blocks 302 through 308 in the past or at least within a certain amount of time, for example. Alternatively, the mobile device can display a screen (not shown) to prompt the user for a confirmation that he or she is aware of no changes to any of the previously entered information.

In certain embodiments, a welcome page (not show) and/or a help page (not shown) can be displayed in connection with any of the setup screens discussed above. For example, a welcome page can be displayed before any other screen. Also, a link to a help page can be displayed on any of the setup screens discussed above. In certain implementations, such a link can be permanently displayed by the mobile device, e.g., in a corner of the display area. Alternatively, the first screen displayed by the mobile device can be any combination of a welcome page, help page, and terms and conditions page.

### Driver's Daily Log (DDL)

Implementations of the disclosed technology can enable a mobile user and/or employer to easily produce driver daily logs with accompanying views and reports for compliance with federal and state transportation regulations, e.g. U.S.D.O.T. §§395.8 and 395.16. Certain implementations also include providing an ability to transmit forms, e.g., as .pdf documents, to virtually any industry destination.

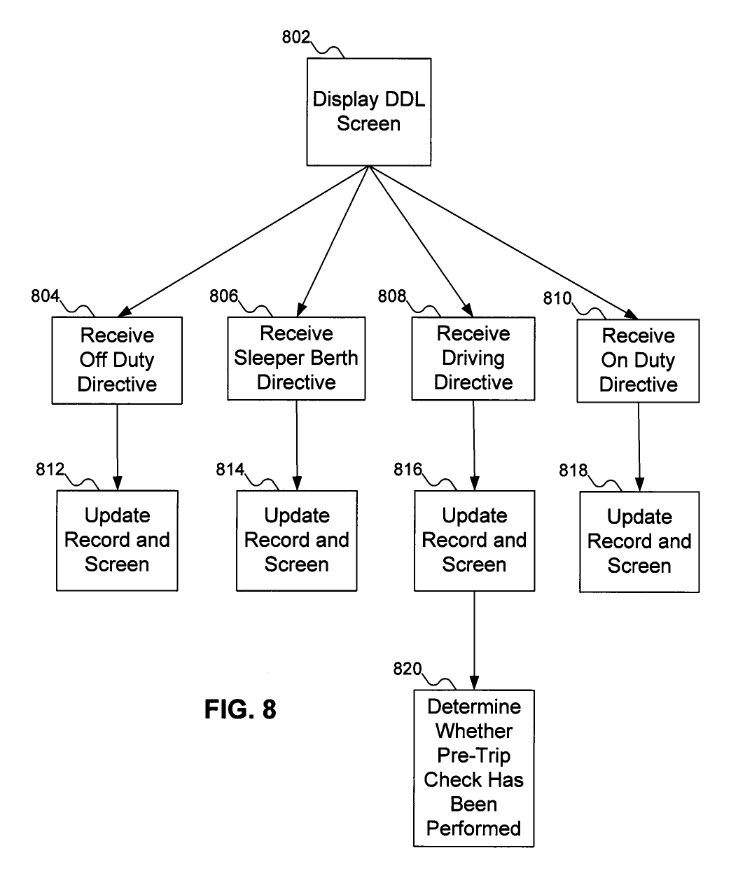

FIG. 8 is a flowchart illustrating an example of a machine-controlled method 800 of entering transportation activity information using a mobile device. At block 802, the mobile device displays a Driver's Daily Log (DDL) screen that can enable the mobile user to enter certain transportation activity information. At block 804, the mobile device receives an “Off Duty” directive from the mobile user. The mobile user can provide the directive by selecting an “Off Duty” button displayed on the DDL screen, for example, when the mobile user is going off duty, e.g., upon reaching the maximum number of hours he or she is allowed to be on the road within a certain time period. Responsive to receiving the directive, the mobile device application updates both the transportation activity record and the DDL screen, as shown at block 812.

At block 806, the mobile device receives a “Sleeper Berth” directive from the mobile user. The mobile user can provide the directive by selecting a “Sleeper Berth” button displayed on the DDL screen, for example, when the mobile user is taking a mandatory break in the vehicle's sleeper berth, e.g., at the end of a driving day. Responsive to receiving the directive, the mobile device application updates both the transportation activity record and the DDL screen, as shown at block 814.

At block 808, the mobile device receives a “Driving” directive from the mobile user. The mobile user can provide the directive by selecting a “Driving” button displayed on the DDL screen, for example, when the mobile user is starting or resuming a drive. Responsive to receiving the directive, the mobile device application updates both the transportation activity record and the DDL screen, as shown at block 816. The mobile device application also determines whether a pre-trip check has been performed, e.g., by prompting the user, as shown at block 820.

At block 810, the mobile device receives a “Sleeper Berth” directive from the mobile user. The mobile user can provide the directive by selecting a “Sleeper Berth” button displayed on the DDL screen, for example, when the mobile user is taking a mandatory break in the vehicle's sleeper berth. Responsive to receiving the directive, the mobile device application updates both the transportation activity record and the DDL screen, as shown at block 818.

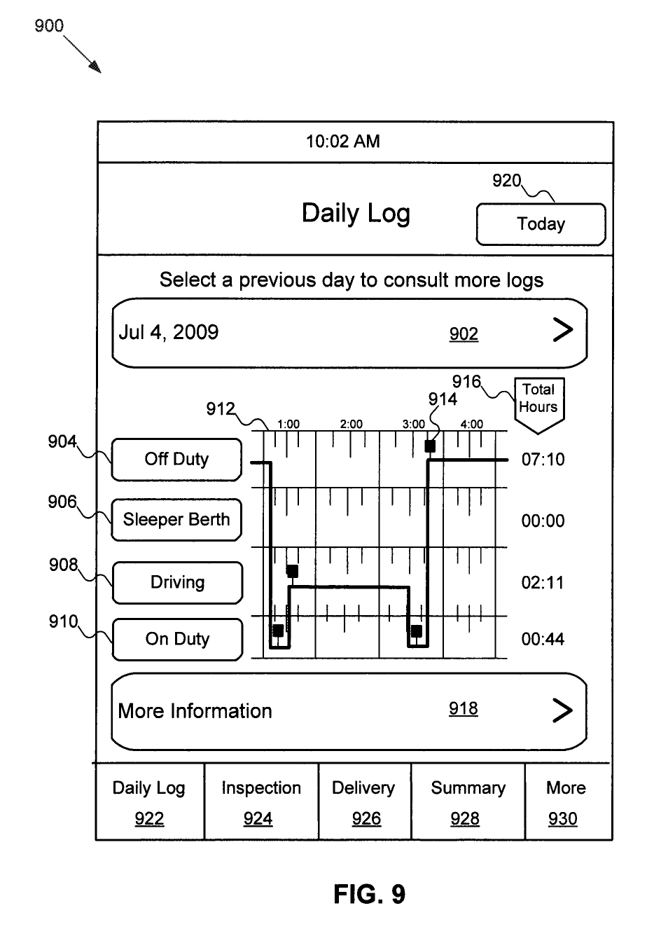

FIG. 9 illustrates an example of a Driver's Daily Log (DDL) screen 900 in accordance with certain implementations of the disclosed technology. The DDL screen 900 includes a date field 902, an “Off Duty” button 904, a “Sleeper Berth” button 906, a “Driving” button 908, and an “On Duty” button 910. When the mobile user presses one of the buttons 904-910, the mobile device application places a virtual pin at a scrolling time grid 912 displayed as part of the DDL screen 900. In certain embodiments, different colors can be used within the scrolling time grid 912 to indicate daytime versus evening.

The DDL screen 900 also includes a “Daily Log” button 922, an “Inspection” button 924, a “Delivery” button 926, a “Summary” button 928, and a “More” button 930. In the example, the “Daily Log” button 922 can be visually presented in a manner different than the other buttons 924-930 to indicate that the corresponding DDL screen 900 is the currently presented view. For example, the “Daily Log” button 922 can be shaded and/or any text or icon within the “Daily Log” button 922 can be bolded or displayed in a color different than any text or icons within the other buttons 924-930. Upon the user selecting the “Inspection” button 924, the “Delivery” button 926, or the “Summary” button 928, the mobile device can display the corresponding Vehicle Inspection screen, Monthly Summary screen, or Delivery screen, respectively, all of which are described elsewhere herein.

In the example, responsive to the mobile user pressing the “Off Duty” button 904 at 3:15, the DDL screen 900 places a virtual pin 914 at a corresponding (x,y) position where x is in line with the “Off Duty” button 904 and y is in line with 3:15 on the time axis. In the example, the DDL screen 900 also draws a line between the newly placed virtual pin 914 and the previously placed virtual pin. The DDL screen 900 can continue to draw the line in the same x-axis until the mobile user presses another one of the buttons 906-910.

In certain embodiments, responsive to the mobile user selecting the “Off Duty” button 904, the mobile device application displays an activity detail screen that displays information such as location, remarks, and pin drops. Once the mobile user saves the information on the screen by pressing a “Save” button, for example, the mobile device application then displays an equipment verification screen to prompt the user to perform an equipment verification. Also, in certain implementations, the mobile user must add a digital signature before going off duty and pressing the “Off Duty” button 904.

In certain embodiments, responsive to the mobile user selecting the “Sleeper Berth” button 906, the mobile device application displays an activity detail screen such as the one described above. In certain implementations, responsive to the mobile user selecting the “Sleeper Berth” button 906, the mobile device application can require the mobile user to indicate that he or she has performed a pre-trip inspection before going on duty or driving again and pressing the “Driving” button 908 or “On Duty” button 910, respectively.

In certain embodiments, responsive to the mobile user selecting the “Driving” button 908, the mobile device application first checks to see if the mobile user has completed a pre-trip inspection. Responsive to the mobile user indicating that he or she has not performed such an inspection, the mobile device application displays a pre-trip inspection screen, which is described elsewhere herein. In certain implementations, the mobile device application will not allow the mobile user to select the “Driving” button 908 until it receives an indication that the pre-trip inspection has been performed. In fact, this is mandated by law. If the mobile device detects movement, the mobile device application will drop a “Driving” pin on the scrolling time grid 912 even if the pre-trip inspection has not been performed.

In certain embodiments, responsive to the mobile user selecting the “On Duty” button 910, the mobile device application displays an activity detail screen such as the one described above. The mobile device application can also provide the mobile user with options for entering a fuel event or a weigh station event.

In certain implementations, the mobile device, e.g., via the DDL screen 900, can display any of a number of additional types of transportation activity information such as the total number of miles driven for the current day, the vehicle and/or trailer number, the name of the carrier, the carrier's main office address, the 24-hour period starting time, the name of a co-driver (if applicable), the total number of hours the driver has been on duty, the total number of hours on the trip, the total number of hours the driver has been on duty for the 7 consecutive day period including the current day, and the total number of hours the driver has been on duty for the prior 8 consecutive day period including the current day, for example. In the case of deliveries, the mobile device, e.g., via the DDL screen 900, can also display shipping document number(s), the name of the shipper, and the commodity, for example.

In certain embodiments, the mobile user's user information can be automatically populated from the mobile user's mobile device settings and calculated values. For example, a “total miles driven today” can be a calculated value taken from location to location the driver has been travelling through, e.g., as entered activities via the DDL screen 900. A GPS feature of the mobile device can be used to obtain the distance between the locations. Alternatively, the difference between the odometer start and finish can be used.

A “total mileage today” can be a calculated value that takes into account all of the miles that the driver accomplished during the day, e.g., as entered via the DDL screen 900. A truck and/or trailer number can be obtained by the mobile device roll control, and names and/or addresses can be taken from the setup information of the mobile device application or from the mobile device settings.

In certain embodiments, the scrolling time grid 912 can auto-scroll to the correct time of day upon initial display. In the example illustrated in FIG. 9, the scrolling time grid 912 has a column 916 that indicates the total number of hours per category. This information can be updated in real-time. In the example, the line extending from the virtual pin 914 will continue to move to the right relative to the scrolling time grid 912, which will scroll to the left as time passes until the mobile user selects another one of the buttons 906-910.

In the example, the current date is displayed within a date field 902. The user can use the date field 902 to select a previous day to view and/or edit information for the previous day. Thus, the mobile user can navigate to previous event records using left/right arrows or by selecting the date to bring up a date barrel roll, for example. If the mobile user has used the date field 902 to bring up information for a different date, the mobile user can subsequently press a “Today” button 920 to return to the current day.

The intersections between activity and time within the scrollable time grid 912 can be touchable and responsive to being selected, cause the opening of a pop up to enable the mobile user to enter log information. At this point, the column indicting the current time can be highlighted. Once the driver logged an event, a virtual pin will be dropped at that intersection. By clicking the virtual pin, the mobile device application can enable the mobile user to edit the corresponding information. Thus, drivers can advantageously edit backwards using the DDL screen 900.

In certain embodiments, an add/edit activity screen can automatically populate the activity and time for a given event, e.g., based on the intersection where the mobile user clicked within the scrollable time grid 912. These values can be edited by the mobile user, e.g., using a mobile device roll control.

Geographic location can be automatically populated from a GPS feature of the mobile device. If there is no immediate Internet connectivity, the mobile user can enter the location manually or mark it as pending, to be remembered when he or she regains Internet connectivity. Comments can also be added or selected from a list of previously entered comments. Returning to the DDL screen 900, the entered events and associated comments can be displayed via a “More Information” sub-section 918.

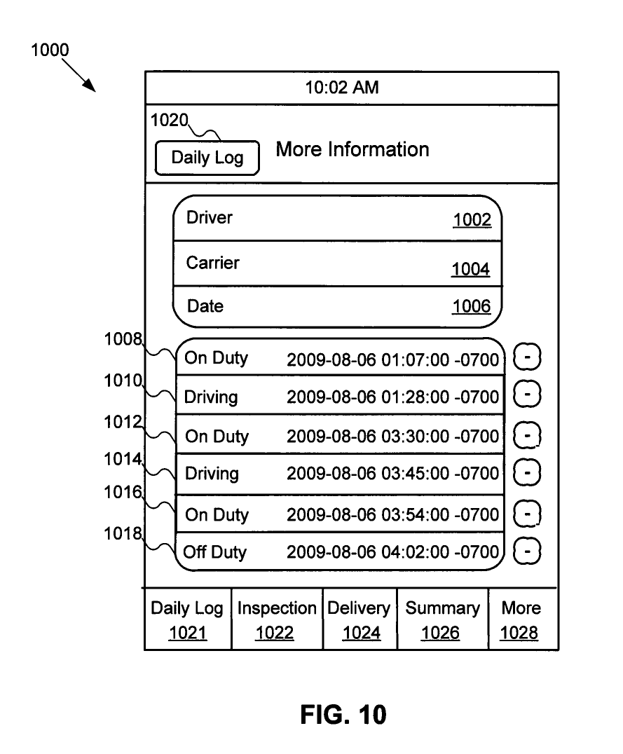

FIG. 10 illustrates an example of a More Information screen 1000 that provides a listing of transportation activity information previously entered using the DDL screen 900, for example. In the example, the More Information screen 1000 includes a Driver field 1002, a Carrier(s) field 1004, a Date field 1006, and a list of event records 1008-1018 pertaining to the previously entered transportation activity information. In the example, certain event records 1008, 1012, and 1016 display times at which the mobile user indicated that he or she was going “on duty,” whereas other event records 1010 and 1014 display times at which the mobile user indicated that he or she was “driving.”

In the example, two “Daily Log” buttons 1020 and 1021 can enable the mobile user to return to the DDL screen 900. “Inspection,” “Delivery,” and “Summary” buttons 1022-1026 can enable the mobile user to go directly to the Vehicle Inspection, Delivery, or Monthly Summary screens, respectively. A “More” button 1028 can provide the mobile user with additional options, such as other screens.

By selecting a particular one of the event records, the mobile user can edit the corresponding information. In situations where a change of more than half an hour is made to log events that are over a week old, the mobile device can prompt the mobile user to turn in corrected logs to his or her employer. Also, if the mobile user is interrupted at any point, the mobile device application can provide an icon that, when selected by the user, can prompt the mobile device to return the previously presented screen to the display.

While the user can edit all fields within the record, all edits can desirably be logged by the system, e.g., into a master log. Master log entries can be set to be non-editable such that original versions of edited material is still available for comparison, for example. Such master logs can be made as tamper-proof as reasonably possible. Also, detected or suspected tampering efforts can be logged.

In certain implementations, the mobile device can store 60 days worth of logs. The mobile device can enable the user to edit any of the logs within that 60 day period. If logs are edited, however, compliance checks can be performed and, if a non-compliant edit is found, an alert can be issued to the mobile user and other parties such as the mobile user's employer, enforcement, etc.

An activity detail screen such as those described above can include the following fields: Activity (which can be auto-populated), Time (which can be auto-populated), and Location (which can be captured and displayed as city/state or latitude/longitude). If the GPS takes too long, e.g., more than 6 seconds, or fails, however, the mobile device can enable the user to enter a location manually. Such situations can be noted in the logs. For example, the GPS can try for 1 minute: if it succeeds, the latitude/longitude can be captured but the city/state entered manually will not be changed).

In certain implementations, a business rule can provide that, if a mobile user is adding to a previous day, the user can change the city/state but not the GPS stamp. In other words, the GPS should capture the mobile user's current location and save that information, e.g., latitude and longitude, to the database. The driver can then enter the city/state manually.

Another field, Location Detail, can be entered manually via a touchscreen, for example, to enter location specific information such as business name. In certain embodiments, GPS data can be recorded with each activity change, even if the location information is overwritten by the driver. The GPS data can be collected every 60 seconds, for example, and be used to calculate city/state. A Remark field can also be displayed as a memo field to enable the mobile user to enter some type of note(s).

Once the mobile user has finishing the data entry/editing, he or she can press a “Save” button within the activity detail screen to prompt the mobile device to save the information and place a corresponding virtual pin on the scrollable time grid 912.

Certain implementations will not allow data entry in situations where the mobile device determines that it is moving faster than 5 miles per hour. For example, the mobile device can provide the mobile user with the following message: “You cannot be driving while you enter data.” In certain embodiments, the mobile device application will automatically select the “Driving” button 908 on the mobile user's behalf if the mobile device determines that the mobile device, and thus the mobile user's vehicle, has been travelling at least 5 miles per hour for a certain period of time, e.g., 15 minutes.

Once the mobile device determines that the mobile device, and thus the vehicle, has stopped after a period of driving, the mobile device application can present the mobile user with a confirmation message suggesting that the mobile user select the “On Duty” button 910 after being stopped for a certain period of time, e.g., 15 minutes.

### Mobile User Alerts

In certain embodiments, a configurable alert can be issued when the mobile device application determines that the mobile user has a specified time, e.g., a certain number of hours and/or minutes, left to drive that day before becoming non-compliant with a transportation rule or guideline, for example. Alternatively or in addition thereto, the mobile device application can issue an alert at a hard time, e.g., 30 minutes remaining, regardless of what the specified time.

In situations where the mobile device has not yet received any indication that a required vehicle inspection, such as a pre-trip inspection, has been completed, the mobile device application can issue an alert notifying the mobile user that he or she should not drive until the pre-trip inspection has been completed.

In certain implementations, an alert can include a reminder. For example, when a driver is going “on duty but not driving,” such as parking the truck, and/or going “off duty,” the mobile device application can display a pop-up box to remind and allow the driver to enter the ending odometer reading for use in future reports, for example.

As used herein, alerts can include visible and/or audible notifications.

### Vehicle Inspections

Vehicle inspections must be performed each time a driver starts a new trip, comes off duty, or adds a new tractor or trailer. By law, a driver cannot begin driving without having completed a pre-trip inspection report. Certain implementations can facilitate such reports by enabling mobile users and/or others such as employers with an ability to easily report vehicle inspections in compliance with federal and state transportation regulations. For example, the system can transmit vehicle inspection reports and any related forms or generated service reports as .pdf documents to particular destinations via email or fax or both.

Drivers must report particular types of failures, especially in relation to sensors. For example, a check must be performed on sensors and errors associated therewith must be reported right away. Certain implementations allow for the running of a diagnostic check on-demand. The mobile device application can also report any sensor failures as they occur. For example, if the mobile device cannot obtain any GPS readings after a specified time interval, e.g., 5 minutes, the application can issue an alert to the mobile user.

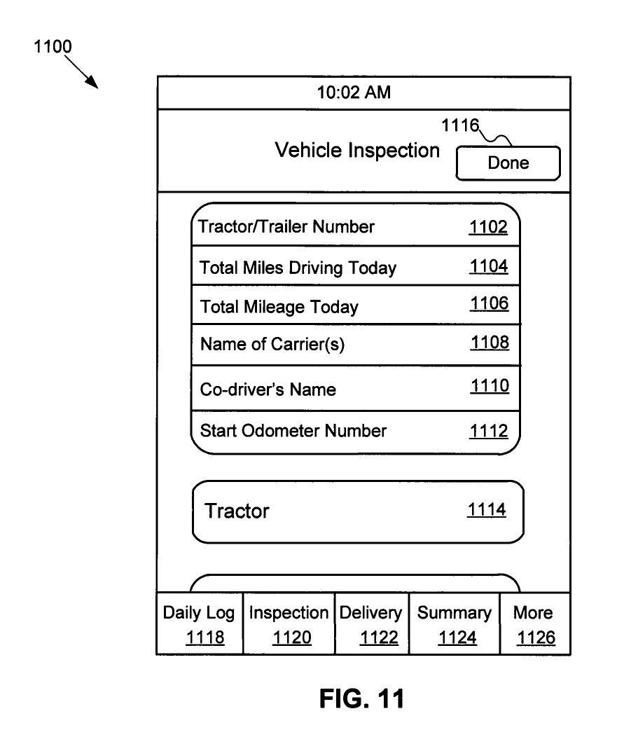

FIG. 11 illustrates an example of a Vehicle Inspection screen 1100 that can include a Tractor/Trailer Number field 1102, a Total Miles Driving Today field 1104, a Total Mileage Today field 1106, a Name of Carrier(s) field 1108, a Co-driver's Name field 1110, and a Start Odometer Number field 1112. Driver's Full Signature and/or Main Terminal Address fields (not shown) can also be included as part of the Vehicle Inspection screen 1100. The user can select a “Done” button 1116 as soon as he or she is finished with the Vehicle Inspection screen 1100.

In situations where the mobile user enters a tractor number into the Tractor/Trailer Number field 1102, a Tractor option 1114 becomes active and, responsive to the user selecting the Tractor option 1114, the mobile device displays a Tractor Inspection screen. In situations where the mobile user enters a tractor number into the Tractor/Trailer Number field, a Trailer option (partially shown below the Tractor option 1114) becomes active and, responsive to the user selecting the Trailer option, the mobile device displays a Trailer Inspection screen. In certain embodiments, the mobile device application stores tractor/trailer number information and can thus retrieve the last tractor and/or trailer number(s) entered via the Vehicle Inspection screen 1100 and automatically populate the Tractor/Trailer Number field 1102 with the pertinent information.

In the example, “Daily Log,” “Delivery,” and “Summary” buttons 1118, 1122, and 1124 can enable the user to go directly to the corresponding DDL, Delivery, or Monthly Summary screens, respectively. A “More” button 1126 can provide the mobile user with additional options. An “Inspection” button 1120 can indicate that the corresponding Vehicle Inspection screen 1100 is the currently presented view. For example, the “Inspection” button 1120 can be shaded and/or any text or icon within the “Inspection” button 1120 can be bolded or displayed in a color different than any text or icons within the other buttons 1118 and 1122-1126.

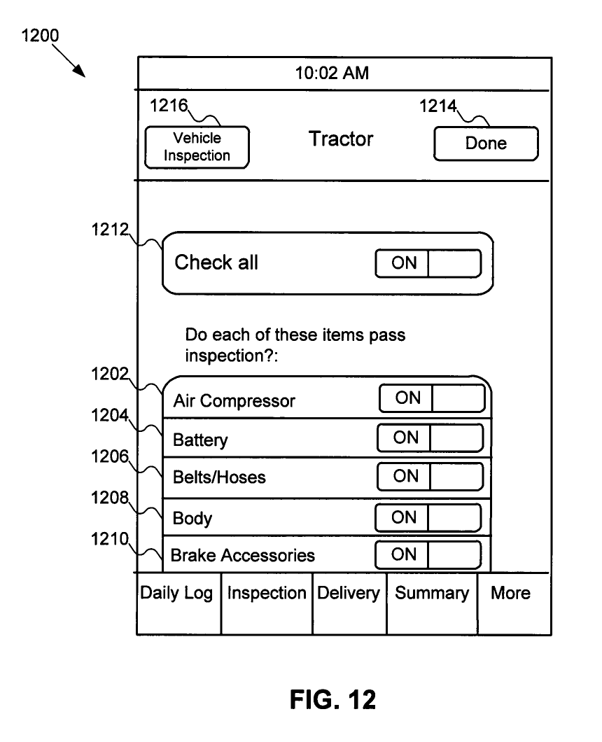

FIG. 12 illustrates an example of a Tractor Inspection screen 1200 that includes a number of fields 1202-1210 that correspond to various items to be checked in connection with an inspection of the corresponding trailer. Once the mobile user has finished using the Tractor Inspection screen 1200, he or she can indicate such action by selecting a “Done” button 1214. Alternatively, the mobile user can press a “Vehicle Inspection” button 1216 at any time to prompt the mobile device to return to the Vehicle Inspection screen 1100.

As the mobile user checks each of the items to be checked while performing the inspection, he or she can indicate that the item has passed by selecting “ON” or, if the item has not passed, the mobile user can select “OFF.” If all of the items pass, the mobile user can select a “Check All” button 1212 to prompt the mobile device to select “ON” for all of the fields 1202-1210. For each item that does not pass the inspection, the mobile device can display a Problems Report screen.

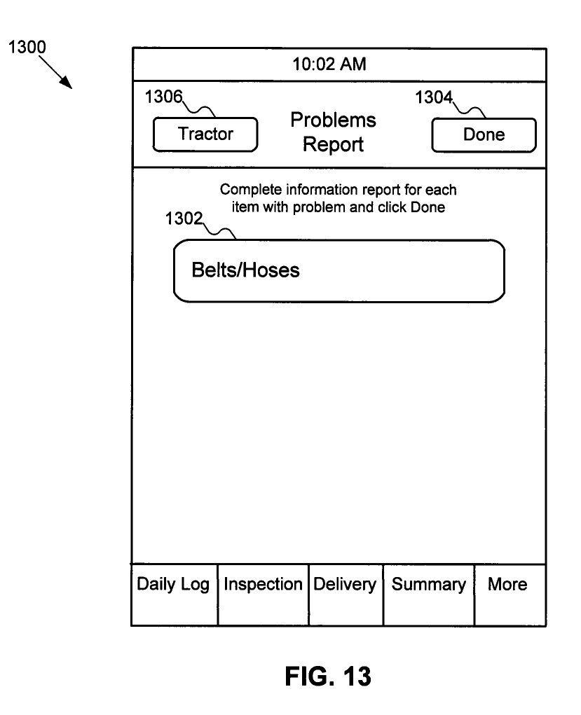

FIG. 13 illustrates an example of a Problems Report screen 1300 that can provide the mobile user with an opportunity to enter information pertaining to the item that failed its inspection. Once the mobile user has finished entering the information, he or she can indicate such action by selecting a “Done” button 1304. Alternatively, the mobile user can return to the Tractor Inspection screen 1200 at any time by pressing a “Tractor” button 1306.

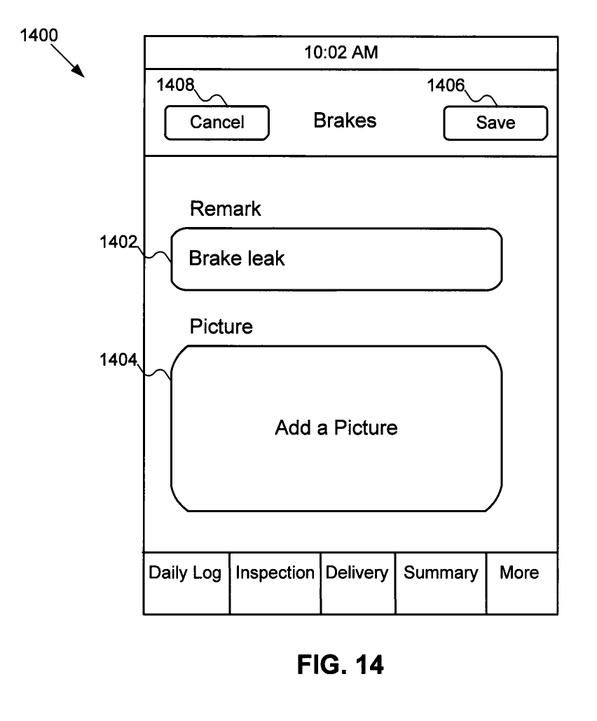

In the example, a problem item field 1302 indicates that there is a problem with belts and/or hoses. By selecting the problem item field 1302, the mobile device application displays a Brakes screen 1400 as illustrated in FIG. 14. The Brakes screen 1400 includes a Remark field 1402 that can enable the mobile user to enter a corresponding remark. A Picture field 1404 can enable the mobile user to attach a photo. For example, the mobile user can take a picture of the problem item using the mobile phone and attach the picture via the Picture field 1404. One having ordinary skill in the art will recognize that other types of files such as audio files, for example, can be used in place of or in addition to picture files.

Once the mobile user has finished entering information using the Brakes screen 1400, he or she can indicate such action by pressing a “Save” button 1406. The mobile device can subsequently email such remarks and photos to appropriate locations along with certain information such as date/time and geographic location. The mobile device application can also copy the mobile user on whatever email correspondence is sent. Once the mobile device has emailed the report, the application can return to a previous screen such as the Tractor Inspection screen 1200 or Vehicle Inspection screen 1100.

Pre-trip inspections must generally be performed each time the driver comes on or off “off duty” and/or adds a new tractor and/or trailer. However, when adding a new trailer only, the tractor does not need to be inspected at that time—only the trailer needs to be inspected.

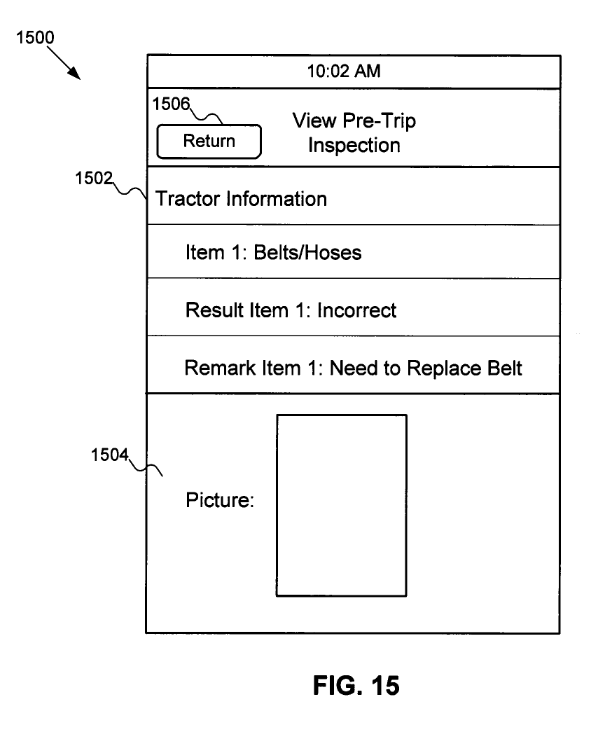

FIG. 15 illustrates an example of a Pre-Trip Inspection screen 1500 that can be used to provide the viewer with information pertaining to a pre-trip inspection that has been performed on the mobile user's vehicle, for example. The Pre-Trip Inspection screen 1500 includes vehicle information 1502, a picture 1504, and a “Return” button 1506 that can be used to return the mobile device application to the previously displayed screen.

### Deliveries

Certain implementations include delivery verification for compliance with industry needs, including an ability for companies to input delivery POD information from databases that are integrated to the mobile device application. Such implementations can also provide companies with an ability to transmit forms as .pdf forms into the mobile device for viewing and signature, for example. The .pdf forms can also be integrated into a company POD .pdf file.

POD information can be created on the mobile device and incorporated with a number of different abilities such as signature capture with scribble screen, voice capture with recording screen, remarks with keyboard screen, and photos with camera screen. Also, time zone fields can be used to list the major time zones without any cities.

### Summary Screens

In certain implementations, a Monthly Summary screen can display the following fields: Driver, Terminal (that is, the name and location, e.g., city and state, of the driver's home terminal), and Month/Year. A description of an example of a Monthly Summary screen follows.

A first column can list days of the month, 1-31 inclusive, plus space for the appropriate number of number of days from the preceding month. For example, one cell can be presented for each day between 1-31.

A second column can provide a total of a driver's “on duty” time, e.g., a total of the driver's “driving” time and “on duty but not driving” time for that day. If the driver did not work on any given day a “0” can be entered for that day.

A third column can show the total number of hours accumulated in the second column for either the last 8 days [for 70-hour drivers] or the last 7 days [for 60-hour drivers]. If a violation is detected, e.g., the driver is over the allowable number of hours, an alert can be issued. Each cell in this column can contain the sum of all the second columns from the last 8 or 7 days.

A fourth column can show a total number of hours accumulated in the second column for either the last 7 days [for 70-hour drivers] or the last 6 days [for 60-hour drivers. Each cell in this column can contain the sum of all of the second columns from the last 8 or 7 days.

A fifth column can include a subtraction of the number entered in the fourth column from either 70 [for 70-hour drivers] or 60 [for 60-hour drivers]. This entry can indicate the number of on-duty hours the driver has available to him or her the next day before being in violation of either the 60 or 70 hour rule, for example.

Certain implementations include a “34-hour restart”—that is, if a driver took 34 consecutive hours off duty, the user would have 70 hours available again and would then begin his or her totaling on the day of the restart and not go back the full 7 or 8 (or 6 or 7) days. Thus, if the system detects 34 consecutive hours in off duty activity, the system can assume that the driver is restarting his or her activities. It should be noted that it is a rolling 7 or 8 days. Though it is calculated on the previous 7 or 8 days, the 34-hour reset does start the total count over again so, if they didn't take a 34 hour off-duty time, the 7 or 8 days would roll over.

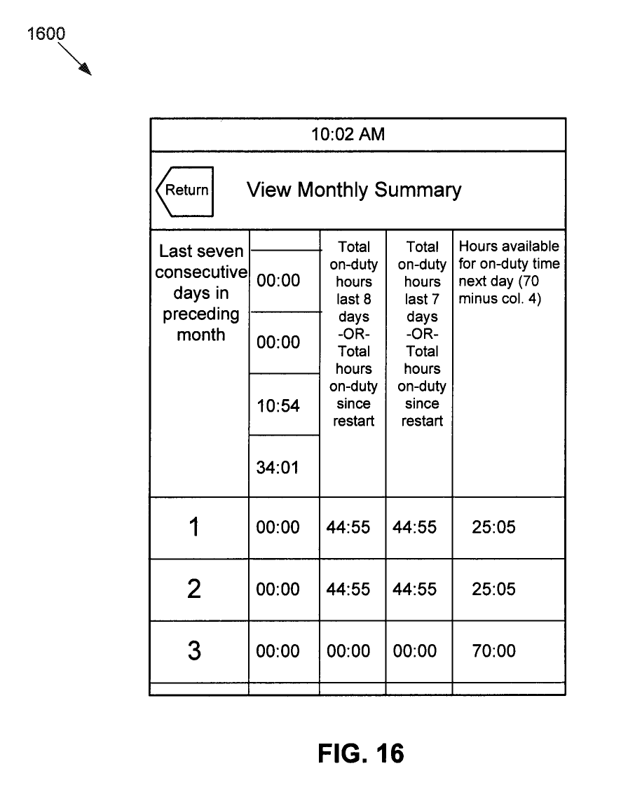

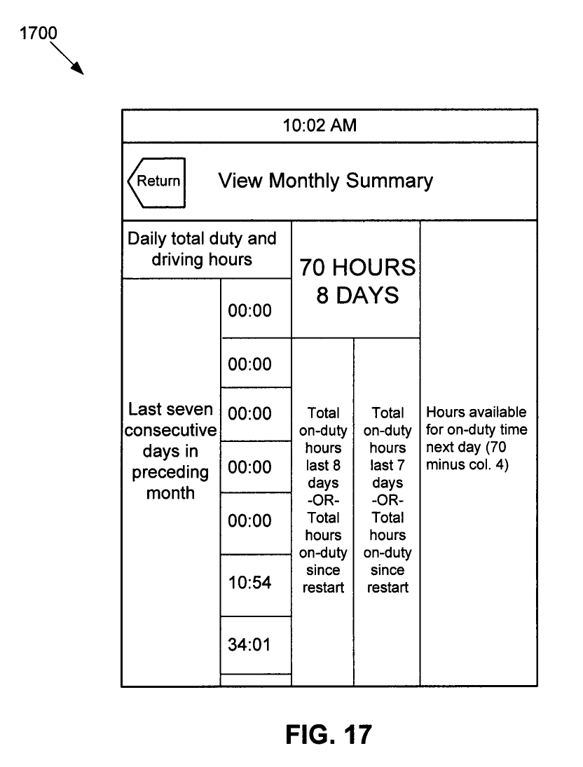

FIGS. 16 and 17 illustrate first and second examples of a Monthly Summary screen 1600 and 1700, respectively.

In certain embodiments, the information collected by a mobile device can be stored on the mobile device and allow the mobile user to review driver log records from the previous 7 days, for example. For example, a driver can pull up his or her own logs to review their accuracy and edit its contents. Geographic places and routes with associated location codes can be recorded with full addresses and unabbreviated names available for reference. Edited data and system failure notifications can also be stored and reported.

### Database-in-the-Sky (DBITS) and Back-End Reporting

Certain implementations include a dynamic back-end database-in-the-sky (DBITS) that can allow for the import and export of data. Such a DBITS can provide 128-bit encryption for all wireless communication, for example. Username and password can be required for actions such as data transmission, entry, and retrieval. In certain embodiments, a company administrator will not be allowed to change data within the database system.

Certain implementations can include notifying the driver that the act of submitting his or her personal driver logs and other recorded data certifies the driver's assertion that the submitted information is true and correct to the best of his or her knowledge. The mobile device application can initiate such a pop-up each time such records are submitted electronically.

In certain embodiments, the DBITS can automatically generate compliance alerts and email a company administrator and/or driver when the alerts occur. The DBITS can also calculate how many miles are driven per driver per state. Each trip can specify the number of miles and hours per carrier, e.g., employer or other company, so that reports can be generated per employer/carrier/company. In addition, the DBITS can have a compliance audit view showing all of the drivers in the company, e.g., if company-based, and then generate reports with drill-down links to supporting data.

Certain implementations include a web site that can enable a user to produce certain types of views, such as industry-specific views, and a wide variety of reports. In certain embodiments, users can view various types of information and then selectively download the information to a .cvs file.

Such information can include a mobile user's daily log and vehicle inspection corresponding to each day. The generated reports can include a listing of pre-trip inspections that were not completed. Such missed inspections can be highlighted or otherwise marked so as to draw attention to themselves. In addition, a signature page can be separately downloaded.

In certain implementations, a 30-day report can be sent to law enforcement via a .pdf file populated by the appropriate information. Furthermore, a USDOT/EOBR certification statement can be included with any of the reports discussed above. Certain implementations thus provide easy access for federal, state, or local officials to review the driver's hours of service in accordance with the requirements of U.S.D.O.T. §395.8 and §395.16, for example. Places and routes with associated location codes recorded with full addresses and unabbreviated names can readily facilitate officer review of such information.

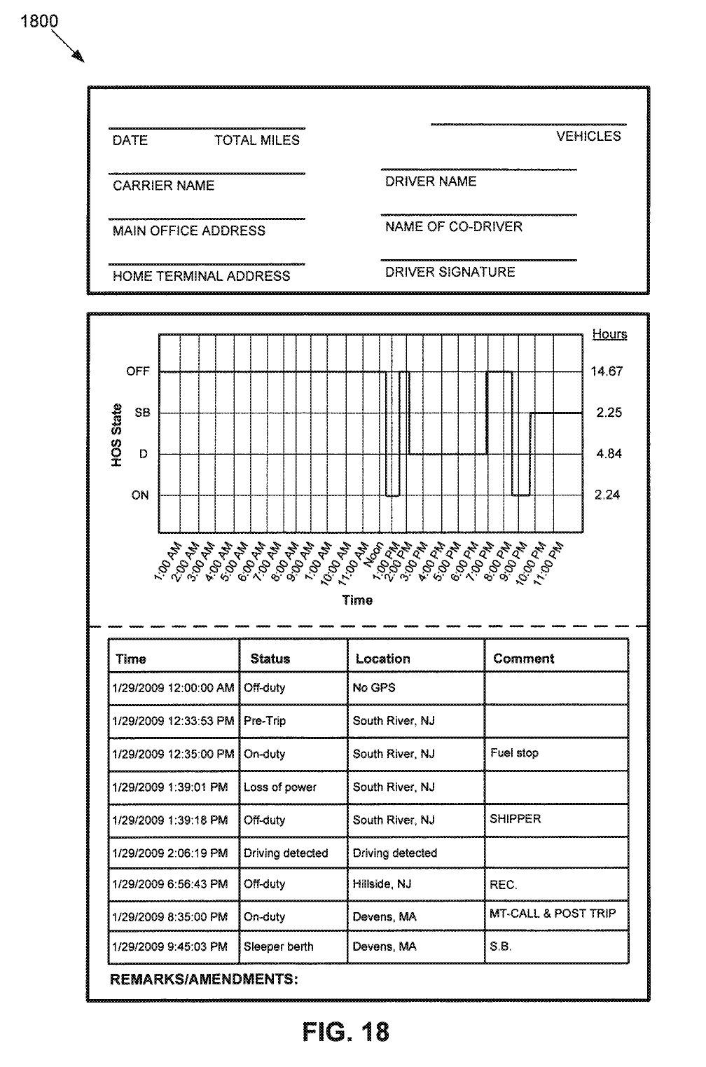

FIG. 18 illustrates an example of a report 1800 in accordance with certain implementations of the disclosed technology. Whereas current systems include drivers filling out similar forms manually, certain implementations of the disclosed technology advantageously include preparing and submitting such forms electronically and, in certain situations, fully automatically. Thus, such forms can be available for enforcement immediately upon request. Also, the submission of such requests can be performed properly, accurately, and in a timely manner. In the example, once the report 1800 has been created, it can be downloaded, printed, and/or submitted electronically to one or more designated parties.

General Description of a Suitable Machine in which Embodiments of the Disclosed Technology can be Implemented

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, and the like.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices (e.g., keyboards and mice), as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, physical storage media.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an implementation of the disclosed technology” or the like are used herein, these phrases are meant to generally reference implementation or embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A machine-controlled method, comprising:
a mobile electronic device capturing transportation activity information corresponding to a particular transportation activity for a user;
the mobile electronic device evaluating the transportation activity information based at least in part on a set of compliance rules; and
responsive to a determination that at least a portion of the transportation activity information is not in conformance with at least one of the set of compliance rules, the mobile electronic device issuing an alert to the user.

2. The machine-controlled method of claim 1, wherein the transportation activity information comprises a certified timestamp.

3. The machine-controlled method of claim 1, wherein the transportation activity information comprises at least a number of miles the user has driven within a particular period of time.

4. The machine-controlled method of claim 3, wherein the alert comprises information pertaining to a maximum number of miles the user can drive within a remaining portion of the particular period of time.

5. The machine-controlled method of claim 1, wherein the transportation activity information comprises at least a number of hours the user has spent driving within a particular period of time.

6. The machine-controlled method of claim 5, wherein the alert comprises information pertaining to a maximum number of hours the user can spend driving within a remaining portion of the particular period of time.

7. The machine-controlled method of claim 1, wherein the alert comprises a notification of a missed vehicle inspection.

8. The machine-controlled method of claim 1, wherein the transportation activity information comprises at least one of an odometer reading and a geographic location.

9. The machine-controlled method of claim 1, wherein the transportation activity information comprises an attachment.

10. The machine-controlled method of claim 9, wherein the attachment comprises an image.

11. The machine-controlled method of claim 1, wherein the particular transportation activity comprises a vehicle inspection.

12. The machine-controlled method of claim 11, wherein the vehicle inspection comprises a pre-trip vehicle inspection.

13. The machine-controlled method of claim 1, wherein the set of compliance rules are in accordance with U.S.D.O.T. §395.8 and §395.16.

14. The machine-controlled method of claim 1, wherein the capturing comprises the mobile electronic device receiving at least some of the transportation activity information from the user via a graphical user interface (GUI).

15. The machine-controlled method of claim 14, further comprising, responsive to the mobile device determining that the user is travelling no less than a minimum speed, the mobile electronic device suppressing the receiving and notifying the user of the suppressing until the user slows to a speed below the minimum speed.

16. The machine-controlled method of claim 1, further comprising the mobile electronic device transmitting at least some of the transportation activity information to a remote database system.

17. The machine-controlled method of claim 1, wherein the transportation activity information comprises a transportation activity identifier selected from a group consisting of the following transportation activity identifiers: “Off Duty,” “Sleeper Berth,” “Driving,” and “On Duty.”

18. An apparatus, comprising:
a transportation activity information capture module operable to capture at least a portion of transportation activity information corresponding to a particular transportation activity;
a transportation activity information receiving module operable to receive at least a portion of the transportation activity information from a user; and
a transportation activity compliance determination module operable to determine whether the transportation activity information is in accordance with a set of compliance rules.

19. The apparatus of claim 18, further comprising an alert generation module operable to generate a user alert responsive to the transportation activity compliance determination module determining that at least some of the transportation activity information is not in accordance with the set of compliance rules.

20. The apparatus of claim 18, further comprising a transportation activity information transmission module operable to transmit at least some of the transportation activity information to a remote database system.

21. The apparatus of claim 18, wherein the transportation activity information receiving module comprises a graphical user interface (GUI).
